(19) United States
(12) Patent Application Publication
(10) Pub. No.: US 2026/0155780 A1
(43) Pub. Date: Jun. 4, 2026

(54) Solar Energy System

(71) Applicants: The Hong Kong University of Science and Technology, Hong Kong (CN); Institute for Advanced Study, Shenzhen University, Shenzhen (CN); Dalian University of Technology, Dalian (CN)

(72) Inventors: Wai Ting FONG, Hong Kong (CN); Hongyu YU, Hong Kong (CN); Ping ZHU, Hong Kong (CN); Xiaozhou YU, Hong Kong (CN); Jingkun LU, Hong Kong (CN); Ruoqin WANG, Hong Kong (CN); Simin YANG, Hong Kong (CN); Yik Kin CHEUNG, Hong Kong (CN)

(21) Appl. No.: 19/390,809

(22) Filed: Nov. 17, 2025

(30) Foreign Application Priority Data
Dec. 3, 2024 (CN) 202411760622.4

(51) Int. Cl. H02S 40/22; H02S 30/20; H02S 40/42

(52) U.S. Cl. CPC H02S 40/22; H02S 30/20; H02S 40/425

(57) ABSTRACT

The present disclosure provides a solar energy system, which comprises: a reflector capable of reflecting sunlight, which is rotatably mounted on a bracket via a pivot shaft and can rotate around the pivot shaft to reflect sunlight to solar energy utilization devices in different designated areas. The reflector has a large area and a small mass, and can be folded so that it occupies a smaller space, and can be unfolded when it operates to reflect sunlight to the solar energy utilization devices.

### FIELD OF THE DISCLOSURE

The present disclosure generally relates to a solar energy system, in particular, to a solar energy system with a reflector.

### BACKGROUND

Solar cells are applied more and more widely in various industries, especially in the aerospace field, such as extra-terrestrial exploration equipment and artificial satellites. However, the application scope of solar cells is limited because their energy conversion efficiency is not high enough or their power is not high enough. Specifically, at present, the photoelectric efficiencies of solar cells are low (usually lower than 40%), and the actual performance of solar energy systems is further affected by operating conditions such as the incident angle of sunlight, the intensity of sunlight and the temperature of the solar cells. In order to improve the power generating efficiency or power generation capacity of a solar energy system, a common practice is to increase the number of solar cells, but a disadvantage of doing so is that the overall mass (and associated cost) of the solar energy system is increased, hindering the practical application of solar energy systems.

Therefore, it is necessary to improve the performance of existing solar power systems, improve the utilization efficiency of solar energy, and improve the adaptability of solar power systems to different application scenarios.

### SUMMARY

The present disclosure provides a novel concentrating solar energy system based on reflection, which can improve the output power of a solar energy system. According to an aspect of the present disclosure, a solar energy utilization device that is adaptive to various incident angles of sunlight and has high output power and light weight is proposed. In the present disclosure, a reflector is used to redirect and focus the sunlight to an area that structurally is not necessarily connected with the reflector. This scheme can support direct and indirect applications of solar energy and expand the application scope of solar energy. The solar energy utilization device in one aspect of the disclosure comprises a solar cell, a device that utilizes solar energy for heating and/or any other device that utilizes solar energy.

In some embodiments of the present disclosure, in a deployed state, the reflector has larger area to reflect more sunlight to the solar cell or the device to be heated or other devices that utilize solar energy, and in a stowed state, the reflector can be folded in a way similar to origami to improve the compactness (i.e., decrease the volume occupied by the stowed reflector) for space tasks, for example.

In the present disclosure, an origami type reflector system is used to redirect and focus sunlight to a designated area. Such enhanced sunlight may be used for power generation via the solar cell, heating or used for other solar energy utilization devices, and the solar cell may be separated from the reflector system structurally. The reflector structure may further be configured and reconfigured according to different light concentration ratios and operating requirements (e.g., it can be directly used for lighting and heating, melting, drilling holes or irradiating other solar panels for charging). The same structure of the disclosure can be used for different types of solar energy applications.

According to an aspect of the present disclosure, a solar energy system is provided, which comprises: a reflector, at least one side of which is coated with a light-reflecting material so that it can reflect sunlight; and a bracket for supporting the reflector; wherein the reflector is rotatably mounted on the bracket via a pivot shaft, and the reflector is rotatable around the pivot shaft to reflect sunlight to at least a designated area.

In some embodiments, the solar energy system further comprises a solar energy utilization device arranged in the designated area, so that the reflector rotates around the pivot shaft to reflect sunlight to the solar energy utilization device.

In some embodiments, the solar energy utilization device comprises one or more items selected from a group consisting of a solar cell and other devices that utilize solar energy.

In some embodiments, the mass of the reflector is smaller than that of the solar cell.

In some embodiments, the mass of the reflector is smaller than that of the solar cell that has area equal to the area of the reflector.

In some embodiments, the reflector is mounted at a position higher than that of the solar cell.

In some embodiments, the solar energy utilization device comprises a plurality of solar energy utilization devices, which are located at different positions, and the reflector reflects sunlight to different solar energy utilization devices at different times.

In some embodiments, the solar energy utilization device (e.g., a solar cell) is not attached to the reflector or the bracket.

In some embodiments, the reflector comprises a plurality of reflectors for reflecting sunlight to the same solar cell or different solar cells.

According to another aspect of the present disclosure, a solar energy system employing a Cassegrain reflector is provided. The solar energy system comprises: a reflector, at least one side of which is coated with a light-reflecting material so that it can reflect sunlight; and a solar energy utilization device; wherein the reflector comprises a primary reflector and a secondary reflector, the primary reflector is provided with an opening, and the solar energy utilization device is arranged at the opening; and wherein the primary reflector is configured as a concave reflective mirror for reflecting sunlight to the secondary reflector, and the secondary reflector further reflects the sunlight to the solar energy utilization device.

In some embodiments, the solar energy utilization device comprises one or more items selected from a group consisting of a solar cell and other devices that utilize solar energy.

In some embodiments, the solar energy utilization device is coupled to the primary reflector through a thermal coupling part, and the thermal coupling part is formed by a good thermal conductor, so that the heat generated by the solar energy utilization device can be conducted to the primary reflector through the thermal coupling part.

In some embodiments, the reflector is foldable; wherein the solar energy system further comprises a driving device for driving the reflector to switch between an expanded state and a retracted state (or stowed state).

In some embodiments, the reflector comprises a plurality of transverse creases extending generally in a transverse direction of the reflector and a plurality of longitudinal creases extending generally in a longitudinal direction of the reflector, and the reflector can be folded along the creases; wherein the longitudinal creases and the transverse creases are perpendicular or at an angle to each other; wherein in the retracted state (or stowed state), each transverse crease is folded in the same way and in a zigzag manner, so that the reflector is retracted in the transverse direction, and odd-numbered transverse creases are located on one side of the reflector in the retracted state while even-numbered transverse creases are located on the opposite side of the reflector in the retracted state.

In some embodiments, each longitudinal crease is folded in a zigzag manner in a plane perpendicular or at an angle to the one side or the opposite side of the reflector, so that the reflector is retracted in the longitudinal direction.

### BRIEF DESCRIPTION OF THE DRAWINGS

The accompanying drawings are used herein to illustrate various embodiments and explain the principles and advantages of the embodiments. In the individual drawings, similar reference numerals refer to the same or functionally similar components/elements, wherein the first digit of a reference numeral on a drawing, which refers to the same or functionally similar element, is consistent with the drawing number of said drawing. Each drawing, together with the following detailed description, is incorporated into and forms a part of the specification. In the figures:

FIG. 1A shows a schematic diagram of a reflective solar energy system according to an embodiment of the present disclosure;

FIG. 1B shows a schematic diagram of a discrete reflective solar energy system according to an embodiment of the present disclosure;

FIG. 2A shows a reflective solar energy system according to an embodiment of the present disclosure, in which a reflector panel is mounted at the top of a supporting structure and a solar energy utilization device panel is mounted at a lower position;

FIG. 2B shows a reflector system with an inclined supporting structure, wherein the inclination angle of the inclined supporting structure is changeable to adjust the inclination angle of the reflector;

FIG. 3 shows a solar energy system using a Cassegrain reflector according to an embodiment of the present disclosure; and

FIGS. 4A and 4B show a foldable reflector according to an embodiment of the present disclosure, wherein FIG. 4A shows a schematic perspective view of the reflector in an unfolded state, while FIG. 4B shows a schematic perspective view of the reflector in a folded state.

### DETAILED DESCRIPTION

In order to make the objects, technical schemes and advantages of the present disclosure understood more clearly, the present disclosure will be further described below in detail in embodiments with reference to the accompanying drawings. It should be understood that the specific embodiments described herein are only exemplary and intended to explain the present disclosure rather than constitute any limitation on the present disclosure.

One way to improve the energy output power of a solar energy utilization device is to concentrate or focus sunlight to a smaller area to enhance the intensity of light irradiated to the solar energy utilization device. On the other hand, the solar cell is arranged in a small area where sunlight is concentrated or focused, and the panel of the solar cell is arranged in that small area, so that the size of the solar cell can be decreased, thereby the mass and cost of the solar energy system can be reduced. The enhanced light intensity further supports the use of a multi-junction (multi-layer) solar cell, which is capable of extracting more total electric energy. At present, there are many ongoing research works research works on concentrated solar cells. As of September 2023, the highest photoelectric conversion efficiency of concentrated solar cells is reported to be 44-48% (compared to under 40% for non-concentrating solar cells). Concentrating systems are especially beneficial to space applications (e.g., spacecrafts, space stations, and lunar rovers, etc.), because concentrating solar cells have reduced masses, and lower requirements for the loading conditions of solar cells in space applications.

There are currently two mainstream solutions for concentrating sunlight for solar energy usage in space applications: a refraction method and a reflection method.

The refraction method relies on optical lenses to focus light to a smaller area where the solar cell is arranged. For example, in the Deep Space-1 Mission (1998-2001), NASA researchers have tested a solar concentrator array, which comprised a plurality of mini circular lenses used as concentrators. Another project involved a loadable concentrator using a flat glass/silicon Fresnel lens. Although these designs are compatible with the existing solar panel array structure, the degree of improvement is affected by the use of refractive lenses. Especially, the base materials (e.g., glass and silicone) of these refractive lenses possess high density; they might also be prone to damage and have a short service life. In addition, the relative positions of the focusing lens and the solar cell are only constrained solar cell along (or parallel to) the focal plane of the lens.

The reflective method uses a reflective surface to redirect and focus light rays. This method can achieve smaller mass (i.e., be lighter weighted) by replacing the heavier lens with a lighter reflective system. However, the existing technologies about space application concentrators are only for providing direct solar energy in the form of heat rather than for power generation.

It can be seen that the existing design of aerospace solar concentrators has some limitations on the concentrating area and the type of use of solar energy. It is necessary to optimize the existing solar power system for space applications.

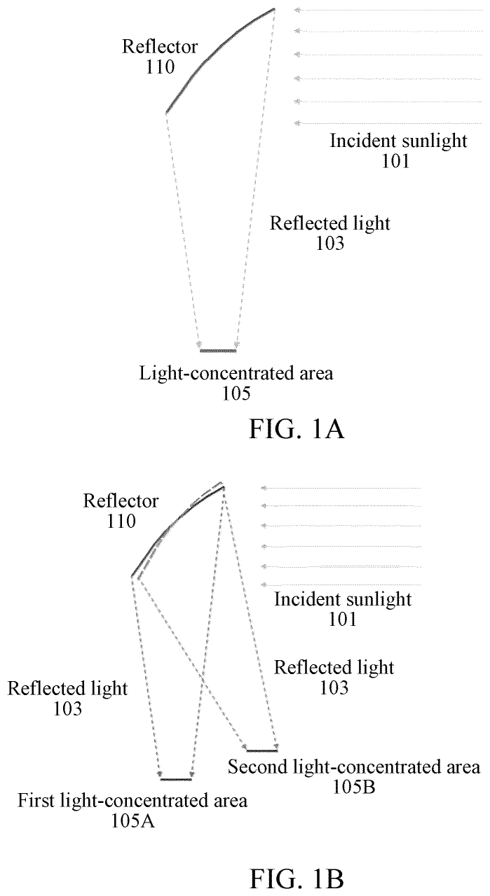

The present disclosure provides a reflective concentrating solar energy system. FIG. 1A shows a schematic diagram of the reflective concentrating solar energy system. The concentrating solar energy system shown in FIG. 1A comprises a reflector 110 in the form of a curved plate, with a concave surface thereof coated with a reflective material to form a concave mirror, which reflects sunlight 101 (or any other light beams) incident on its surface to another direction and can concentrate approximately parallel incident sunlight 101 to a light-concentrated area 105 with smaller area. The area of the light-concentrated area 105 is smaller than that of the concave mirror of the reflector 110, thus, the light intensity of the reflected light 103 in the light-concentrated area is higher than that of the incident sunlight 101. In addition, a solar panel (not shown in the figure) is arranged in the light-concentrated area 105. Owing to the fact that the light intensity in the concentrating area 105 is higher than that of the incident sunlight 101, the solar panel arranged in the concentrating area 105 receives incident light in higher intensity, thereby outputs electric energy at higher power.

In addition, the reflective surface of the reflector may be formed by different types of surfaces, including but not limit to a parabolic surface or a multi-segment surface, etc., and the multi-segment surface comprises foldable surfaces (or curved surfaces) formed by a plurality of planar units.

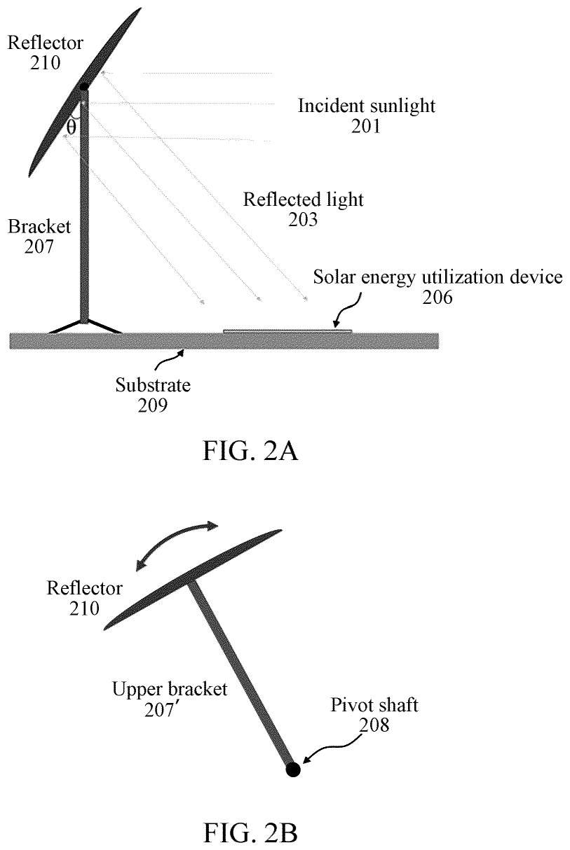

FIG. 2A shows a solar energy system according to some embodiments of the present disclosure, which comprises a reflector 210, a bracket 207 that supports the reflector 210 and is fixed to a substrate 209, and a solar cell (or other solar energy utilization device, the same applies hereinafter) 206. In the embodiment shown in FIG. 2A, the solar cell 206 is attached to the surface of the substrate 209. The incident sunlight 201 is reflected by the reflector 210, and the reflected light 203 irradiates to the solar cell 206 to generate electricity. The substrate 209 may be the ground (or the surface of another planet, such as the surface of the moon) or the roof or wall of a building, an outer surface of a spacecraft or exposed components of the spacecraft.

The reflector 210 is rotatably coupled to the bracket 207 via a pivot shaft, so that an angle θ between the reflector 210 and the vertical direction can be adjusted to reflect the sunlight 201 to a desired position, for example, to the solar cell 206.

In some application scenarios, the position where the solar cell is located may be shadowed by other objects, including for instance buildings, tall equipment or environmental tall structures, which block the sunlight directly irradiated to the solar cell or may reduce the time of direct irradiation of the sunlight on the solar cell. The reflector 210 shown in FIG. 2A is arranged at a position where it can be directly irradiated by the sunlight 201, or at a position where it can be directly irradiated by the sunlight 201 for a long time. The reflector 210 reflects the sunlight to the solar cell 206, so that the solar cell 206 still can output electricity at high power when it is in the shadow of any other objects.

Moreover, the solar energy system according to the present disclosure is especially suitable for use under a high incident angle sunlight condition, such as in a polar region. In a polar region, the incident angle of sunlight relative to vertical direction is larger, or the incident angle for a solar cell arranged in parallel to the ground (i.e., the angle between the light propagation direction and the normal direction of the surface of the solar cell) is larger, and the propagation direction of the sunlight is close to the direction in parallel to the surface of the solar panel. In such a case, with the reflector according to the present disclosure, the sunlight is reflected to the solar cell at a smaller incident angle, thereby the power output efficiency of the solar cell is improved.

FIG. 2B shows a variant of the solar energy system in FIG. 2A, in which an upper bracket 207′ of the solar energy system is coupled to a lower bracket (not shown) via a pivot shaft 208, so that the reflector 210 fixed to the upper bracket 207′ can rotate around the pivot shaft 208 along with the upper bracket 207′, so as to adjust the reflex angle of the sunlight and make the sunlight reflected to the solar cell or other solar energy utilization device.

In another modified embodiment, two pivot shafts are arranged on the bracket (207, 207′) in a way that they are perpendicular or at an angle to each other, so that the reflector 210 can rotate independently around the two pivot shafts, respectively, in other words, the reflector has two degrees of freedom of rotation, thereby the reflector can be more flexibly redirected to more directions to reflect the incident light to even more desired positions/directions.

In the embodiment shown in FIGS. 2A and 2B, although the reflective surface of the reflector 210 is shown as a planar surface, those skilled in the art can readily understand that the reflective surface of the reflector 210 may be replaced with a curved surface as shown in FIGS. 1A and 1B, so as to concentrate sunlight to a light-concentrated area or on the solar cell.

As described above, the solar energy system of the present disclosure is suitable for use in situations where the sunlight is often blocked of shadowed. With the solar energy system of the present disclosure, as along as the reflector (110, 210) is placed in an area exposed to direct sunshine, the solar cell or an object or device to be heated may be arranged in a shadowed area and can receive reflected light rays from the reflector, and the solar cell or the object or device to be heated may be physically separated from the reflector (110, 210). Thus, the application of the solar energy system of the present disclosure is more flexible to be deployed in a variety of environments.

In addition, for a power generation applications, the solar cell 206 may be arranged on the ground (the surface of the earth or the surface of the moon, or other planets), so that the solar cell can be maintained at a cold temperature that is the same as or close to the temperature of the ground which is shadowed from sunshine, to avoid a degraded photoelectric conversion efficiency of the solar cell 206 owing to temperature rise.

In addition, traditionally, the solar cells are mounted at the top of the bracket away from the ground to receive solar irradiation. In some applications, a solar cell mounted on the bracket can be rotated as the sun traverses the sky, thereby it receives the solar irradiation more extensively. However, it is well known that the solar panels are heavy and it takes energy both to mount the solar panel at a high level (the top of the bracket) and to rotate it. The reflector 110 in the present disclosure is light in weight, and in some embodiments, the reflector 110 is made of a fabric material, such as the material of an umbrella cover, coated with a reflective material on at least one side thereof. Such a thin and light device can be mounted at the top of a bracket more easily, and the energy consumed for rotating such a light-weight reflector 110 is much less than that consumed for rotating a conventional solar panel.

Moreover, in some embodiments of the present disclosure, the bracket 207 is used to support a reflector having small mass rather than to support a solar cell having high mass. Therefore, the supporting strength and the mass required for the bracket 207 can also be significantly reduced, thereby the mass of the entire system can be reduced. Compared with a scheme of lifting the entire solar panel to the top of the bracket 207 to obtain stronger illuminance, the solar energy system of the present disclosure is expected to save 30-50% of the mass of the solar system in a power generation application.

Now refer to FIG. 1B, which illustrates a schematic diagram of a discrete reflective solar energy system according to an embodiment of the present disclosure, wherein, two positions (or two orientations) of a concave mirror reflector 110 are shown. At one position, the reflector 110 reflects the incident sunlight 101 to a first light-concentrated area 105A; after the reflector 110 is rotated to another position (shown by the dotted line), i.e., a second position, the reflector 110 reflects the incident sunlight 101 to a second light-concentrated area 105B. The first light-concentrated area 105A and the second light-concentrated area 105B may be adjacent to each other, or may be spaced apart from each other by a distance.

The scheme of arranging two light-concentrated areas provides greater flexibility for practical applications. Assuming a scenario in which two solar cells are arranged in the first light-concentrated area 105A and the second light-concentrated area 105B, respectively, but there exist tall objects around them, such as high equipment or buildings; at one moment, under sunlight illumination, the shadow of a tall object covers the first light-concentrated area 105A, resulting in reduction in electric power output of the solar cell located in the first light-concentrated area 105A because it is not in direct sunlight, while the solar cell in the second light-concentrated area 105a can generate electric power efficiently because it is in direct sunlight. In such a scenario, with the solar energy system of the present disclosure, the reflector 110 is able to be rotated so that the reflected light towards the solar cell in the first light-concentrated area 105A while it is shadowed, thereby the power output of the solar cell located in the first light-concentrated area 105A is improved. As the sun traverses the sky, when the shadow of the tall object exits the first light-concentrated area 105A and covers the second light-concentrated area 105B, the reflector 110 can be rotated so as to reflect sunlight to the solar cell in the second light-concentrated area 105B, thereby the solar cell continues outputting electric power efficiently.

In other embodiments, more than two light-concentrated areas may be arranged, and the incident sunlight 101 may be reflected to the respective light-concentrated areas (at different times) by rotating the reflector 110, so as to improve the power generation efficiency of the solar cells in the respective irradiated areas. In addition, two or more reflectors 110 may be provided to reflect sunlight to the same light-concentrated area or different light-concentrated areas at the same time.

As can be seen from the above description, the reflector 110 in the present disclosure can redirect focused sunlight to a plurality of different positions/areas, including those positions/areas that are structurally separated from the reflector.

By reflecting sunlight to different light-concentrated areas (or irradiated areas) through rotating the reflector 110, the amount of sunlight irradiated to these areas can be further enhanced. In this way, it is helpful for supplying electric power to and charging some mobile devices/equipment.

In addition, since the reflector can be configured to provide concentrated sunlight to different areas (at different times) respectively, in some embodiments, an array of a plurality of solar cells may share the same reflector.

In the above embodiments, solar cells are located in the respective light-concentrated areas or areas which may be irradiated by the reflected light, but the present disclosure is not limited thereto. In the application of the present disclosure, devices or objects instead of solar cells which are to be maintained at a specific temperature may be located in the light-concentrated areas or the areas irradiated by the reflected sunlight. Some devices (e.g., computers and experimental equipment) are not suitable for operating at low temperatures or can't operate efficiently at low temperatures, therefore it is necessary to heat the devices to maintain them at a temperature above a specific value. The reflector in the present disclosure can be used to reflect/concentrate sunlight on such devices to increase their temperature. According to the present disclosure, it is unnecessary that the heated devices arranged in the light-concentrated areas or the areas irradiated by the reflected light have physical connections or link with the reflector. In this aspect, the device of the present disclosure is especially suitable for use in cold areas, such as polar regions of earth or any other planets, and it is also suitable for devices or objects that are mounted in shadowed areas all the year round and meanwhile should be maintained at specific temperatures, so as to prevent damages caused by low temperature.

In the above embodiments, although only one reflector is illustrated as an example, the present disclosure is not limited thereto. A plurality of reflectors may be used to reflect/concentrate sunlight to the same area or different areas.

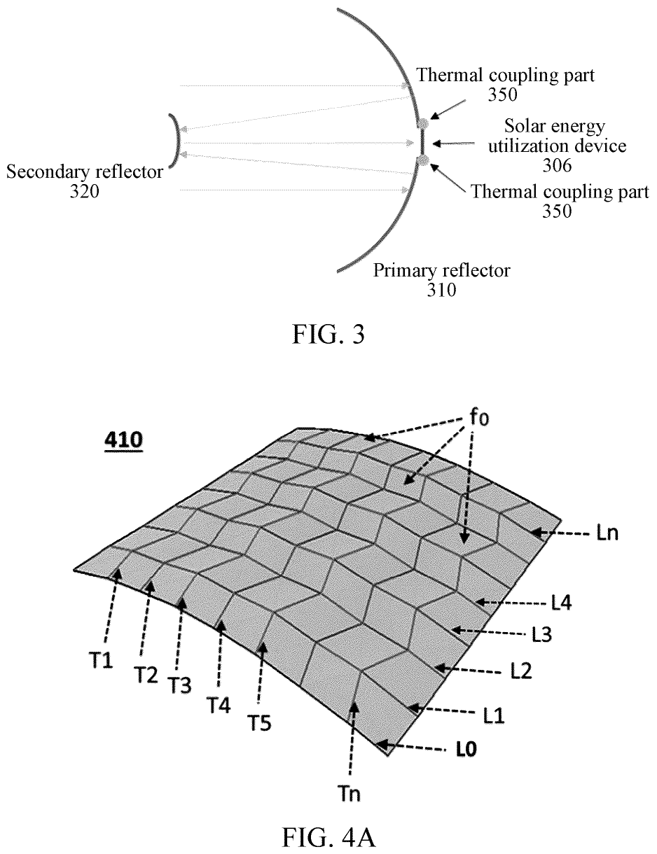

FIG. 3 shows a solar energy system using a Cassegrain reflector according to some other embodiments of the present disclosure. As shown in FIG. 3, the Cassegrain reflector comprises two reflectors, i.e., a primary reflector 310 in a larger size and a secondary reflector 320 in a smaller size. The primary reflector 310 is in the form of a concave reflective mirror, an opening is arranged at the center of the primary reflector 310, and a solar cell 306 is arranged in the opening and faces the secondary reflector 320. The primary reflector 310 and the secondary reflector 320 are arranged in a way that the primary reflector 310 concentrates the incident sunlight to the secondary reflector 320, and the secondary reflector 320 reflects again the sunlight incoming from the primary reflector 310 to the solar cell 306, so as to make the solar cell 306 generate electricity. Compared with the embodiments shown in FIGS. 1A, 1B and 2A, 2B, the embodiment using a Cassegrain reflector shown in FIG. 3 reduces the total volume of the solar energy system, because the solar cell 306 is not arranged away from the reflector; on the contrary, the solar cell 306 is arranged in close proximity to the primary reflector 310. This scheme is beneficial to a solar energy system that needs to be deployed in a limited space.

In some embodiments, the solar cell 306 may be replaced by other solar energy utilization device.

In some embodiments, the solar cell 306 in the solar energy system as shown in FIG. 3 is coupled to the primary reflector 310 through a thermal coupling part 350. The thermal coupling part 350 is composed of a good thermal conductor, so that the heat generated on the solar cell 306 can be efficiently transferred to the primary reflector 310 through the thermal coupling part 350. In some embodiments, the thermal coupling part 350 is made of metal; for example, the thermal coupling part 350 is made of a copper wick heat pipe. The temperature of a solar cell may be increased after a long time of electricity generation, resulting in a degraded photoelectric conversion efficiency of the solar cell, especially in a case that the solar cell operates in a high temperature environment. In some embodiments, the primary reflector 310 comprises a good thermal conductor material and can be used as a heat sink and radiator to reduce the temperature of the solar cell 306. In the embodiment, the heat generated by the solar cell 306 can be conducted to the primary reflector 310 through the thermal coupling part 350, and the primary reflector 310 acts as a heat sink for the solar cell 306, thereby suppresses the temperature rise of the solar cell 306, so that the solar cell 306 is maintained at a high photoelectric conversion efficiency.

In addition, in the prior art, in a solar energy system using a concave reflective mirror, a device receiving solar energy (e.g., a solar panel) is usually arranged at the focal point of the concave reflective mirror, so that the device that receives solar energy is separated by a certain distance from the concave reflective mirror or the reflector that reflects sunlight; as a result, the heat generated on the device receiving solar energy can't be transferred to the reflector or radiated to the environment through the reflector, thus, it is difficult to cool the device receiving solar energy. In contrast, in the embodiment shown in FIG. 3, the solar cell 306 is not spaced apart from the primary reflector 310. On the contrary, the solar cell 306 is arranged in close proximity to the primary reflector 310, and the solar cell 306 is linked to the primary reflector 310 via a material having high thermal conductivity (i.e., the thermal coupling part 350), so that the heat of the solar cell 306 can be efficiently conducted to the primary reflector 310 and then radiated to the surrounding environment.

Moreover, in the embodiment shown in FIG. 3, the secondary reflector 320 may be a convex mirror or a mirror in a different shape, such as a planar reflective mirror, which can reflect the light incoming from the primary reflector 310 to the solar cell 306.

In other embodiments, the two types of reflectors (single reflector and Cassegrain reflector system) should be foldable, especially for space applications where the entire system should be folded and stowed in a smaller space for launching. In some embodiments, the reflector is folded according to an origami pattern, such as Miura fold, to make better use of the internal space of an aircraft. By folding according to an origami pattern, the folding process of the reflector is easy to control (without highly complicated control).

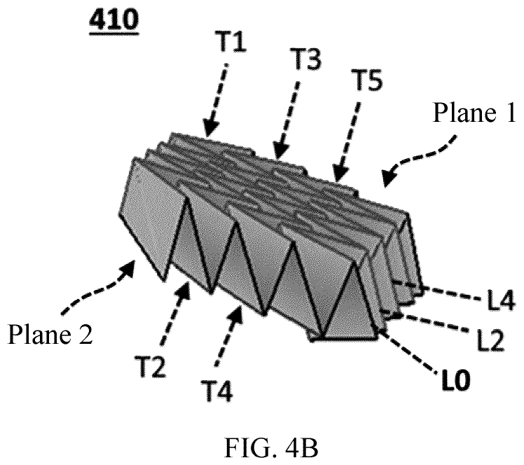

Although antennas and some solar panels in space applications can be folded in multiple manners, the origami pattern in the present disclosure can achieve a higher compactness in a folded/retracted state and enable the reflector to be redeployed (e.g., for different solar energy utilization devices, or even for different focal lengths). Under some conditions, the reflector can still be folded in other traditional mechanisms. FIGS. 4A and 4B show a possible origami pattern that can be used to fold the reflector.

FIG. 4A is a schematic perspective view of the reflector according to some embodiments of the present disclosure in an unfolded state, while FIG. 4B shows a schematic perspective view of the reflector in FIG. 4A in a folded state in which the reflector is folded according to an origami pattern.

As shown in FIG. 4A, the reflector 410 is generally rectangular, and creases formed in longitudinal and transverse directions are shown in the figure. Transverse creases T1, T2, T3, T4, T5, ..., Tn and longitudinal creases L1, L2, ... Ln that are arranged sequentially are marked in the figure. The transverse creases T1, T2, T3, T4, T5, ..., Tn extend generally in the transverse direction of the reflector 410, and the longitudinal creases L1, L2, ..., Ln extend generally in the longitudinal direction of the reflector 410. The transverse direction and the longitudinal direction are perpendicular to each other or at an angle between 0° and 90° to each other. In addition, a side L0 of the reflector 410 extending in the longitudinal direction is further marked in FIG. 4A.

Moreover, as shown in the embodiment shown in FIG. 4A, each of the transverse creases T1, T2, T3, T4, T5, ..., Tn is a folding line. Specifically, the crease T1 extends from the side L0 of the reflector 410 in a first direction, intersects with the longitudinal crease L1, and then changes to extend in a second direction, which is different from the first direction. Following intersection with the longitudinal crease L2, the crease T1 changes back to extend in the first direction. In other words, the crease T1 changes its direction of extension once intersecting with a longitudinal crease. Other transverse creases are also arranged in a similar way.

The longitudinal creases L1, L2, L3, L4, ..., Ln are also configured as folding lines, and, similar to the transverse creases, each longitudinal crease changes its direction of extension at each intersection with a transverse crease.

The transverse creases and the longitudinal creases intersect with each other, so that the entire reflector 410 is divided into a plurality of pieces f₀. Each piece f₀ is quadrilateral, for example, a parallelogram.

In some embodiments, each piece f₀ is formed into a sheet made of a rigid material, and each sheet is rotatably coupled with an adjacent sheet. Any methods known to those skilled in the art can be used to couple the separate small pieces f₀ together. In such a case, the creases refer to the dividing lines between adjacent small pieces f₀. Alternatively, the narrow gaps between adjacent small pieces f₀ are approximately regarded as lines, i.e., creases.

In other embodiments, the reflector 410 is formed by an entire piece of flexible cloth, and one side of the flexible cloth has a reflective layer or reflective material for reflecting sunlight. In such a case, the creases are linear traces along which the flexible cloth may be folded.

The reflector 410 as shown in FIG. 4A can be folded (retracted). In the process of folding, according to an embodiment, odd-numbered transverse creases T1, T3, T5, etc. move upward, while even-numbered transverse creases T2, T4, etc. move in an opposite direction. In addition, each longitudinal crease is folded repeatedly in a zigzag shape, and adjacent longitudinal creases get close to each other. Finally, the reflector is folded into the state shown in FIG. 4B, in which odd-numbered transverse creases T1, T3, T5, etc. are located on the upper side of the folded (retracted) reflector 410, while even-number transverse creases T2, T4, etc. are located on the opposite side of the folded (retracted) reflector 410. In addition, as can be seen in FIG. 4B, each odd-numbered transverse crease T1, T3, T5, etc. is folded in a zigzag shape, so that each odd-numbered transverse crease is retracted in the transverse direction, and the odd-numbered transverse creases T1, T3, T5, etc. are in the same trend of extension. Specifically, for example, the crease T1 extends from one end point in a third direction first, then turns back to extend in a fourth direction after it reaches a bottom vertex (intersection point with a longitudinal crease), and then turns back to extend in the third direction after it reaches the next vertex. Each odd-numbered transverse crease is folded in a zigzag shape in the same way, so that the vertexes of a crease are inserted into corresponding valleys of an adjacent crease, thereby the odd-numbered transverse creases T1, T3, T5, etc. can get close to each other.

On the other side of the reflector 410 in the retracted state, even-numbered transverse creases T2, T4, etc. are also folded in a zigzag shape in the same way, so that they get close to each other.

For the reflector 410 in the retracted state as shown in FIG. 4B, the plane where the odd-numbered transverse creases T1, T3, T5, etc. are located are generally parallel to the plane where the even-numbered transverse creases T2, T4, etc. are located. Here, the two planes are generally referred to as Plane 1 and Plane 2 respectively. Each longitudinal crease L1, L2, L3, L4, ..., Ln is folded in a zigzag shape in a plane perpendicular or at an angle to the Plane 1 and the Plane 2, just as the edge L0 of the reflector 410 is folded in a zigzag shape, so that each longitudinal crease is retracted in the longitudinal direction.

As described above and shown in FIG. 4B, in some embodiments, upon being folded, both its longitudinal dimension and its transverse dimension of the reflector 410 are greatly reduced, so that the reflector can be held in a small space conveniently, for example, in a spacecraft.

In the illustrated embodiments, each small piece f₀ is shown as a parallelogram, but the present disclosure is not limited thereto, and each small piece f₀ may be in other shapes. Moreover, in some embodiments, the small piece f₀ are in the same shape and size; in other embodiments, some small pieces f₀ may be different from other small pieces f₀ in shape and size.

Although the reflector 410 is shown as a rectangle in FIG. 4A, the present disclosure is not limited thereto. In some other embodiments, the reflector 410 is in other desired shapes, for example, a circular shape. Moreover, the reflector 410 is not limited to a planar structure; instead, it may have a curved structure to achieve a desired light focusing effect.

Each of the small pieces f₀ constituting the reflector 410 may be made of a rigid material, including a good thermal conductor material (e.g., metal), so as to dissipate the heat of the solar cell mounted adjacently to the reflector 410 (in the case of a Cassegrain reflector).

In addition, in the embodiment described above, the solar energy system further comprises a driving device for driving the reflector to switch between an expanded state and a retracted state. The driving device may use any means known to those skilled in the art to drive the reflector for switching.

Although exemplary embodiments have been presented in the above detailed description of the embodiments, it should be understood that there are numerous variations. It should also be understood that the exemplary embodiments are only examples and are not intended to limit the scope, applicability, operation or configuration of the present disclosure in any way. On the contrary, the above detailed description provides a convenient road map for those skilled in the art to implement the exemplary embodiments of the present disclosure, and it should be understood that various modifications can be made to the functions and arrangement of the steps and the operation methods described in the exemplary embodiments without departing from the scope of the present disclosure as set forth in the appended claims.

What is claimed is:

1. A solar energy system, comprising:
a reflector, at least one side of which is coated with a light-reflecting material so as to reflect sunlight; and
a bracket for supporting the reflector;
wherein the reflector is rotatably mounted on the bracket via a pivot shaft, and the reflector is rotatable around the pivot shaft to reflect sunlight to at least a designated area.

2. The solar energy system according to claim 1, further comprising a solar energy utilization device arranged in the designated area, wherein the reflector rotates around the pivot shaft to reflect sunlight to the solar energy utilization device, and
wherein the solar energy utilization device comprises one or more items selected from a group consisting of a solar cell and other devices that utilize solar energy.

3. The solar energy system according to claim 1, wherein
a mass of the reflector is smaller than that of a solar cell that has an area equal to an area of the reflector.

4. The solar energy system according to claim 2, wherein
the reflector is mounted at a position higher than that of the solar cell.

5. The solar energy system according to claim 2, wherein the solar energy utilization device comprises a plurality of solar energy utilization devices arranged at different positions, and wherein the reflector reflects sunlight to different solar energy utilization devices at different times.

6. The solar energy system according to claim 2, wherein the solar energy utilization device is not attached to the reflector or the bracket.

7. The solar energy system according to claim 2, wherein the reflector comprises a plurality of reflectors for reflecting sunlight to the same solar energy utilization device or different solar energy utilization devices.

8. The solar energy system according to claim 1, wherein the reflector is a concave mirror for concentrating sunlight to a designated area.

9. The solar energy system according to claim 1, wherein the bracket comprises an upper bracket and a lower bracket, and wherein the upper bracket is coupled to the lower bracket via a pivot shaft, and the reflector is coupled to the upper bracket, so that the upper bracket is rotatable with respect to the lower bracket, thereby the inclination angle of the reflector is changed and the direction of reflected light is changed accordingly.

10. A solar energy system, comprising:
a reflector, at least one side of which is coated with a light-reflecting material so to reflect sunlight; and
a solar energy utilization device;
wherein the reflector comprises a primary reflector and a secondary reflector, the primary reflector is provided with an opening, and the solar energy utilization device is disposed at the opening;
wherein the primary reflector is configured as a concave reflecting mirror and is arranged to reflect sunlight to the secondary reflector, and the secondary reflector further reflects the sunlight to the solar energy utilization device;
and wherein the solar energy utilization device comprises one or more items selected from a group consisting of a solar cell and other devices that utilize solar energy.

11. The solar energy system according to claim 10, wherein the solar energy utilization device is coupled to the primary reflector through a thermal coupling part, and the thermal coupling part is composed of a good thermal conductor, so that heat generated by the solar energy utilization device is conducted to the primary reflector through the thermal coupling part.

12. The solar energy system according to claim 11, wherein the thermal coupling part is composed of a copper wick heat pipe.

13. The solar energy system according to claim 11, wherein the primary reflector comprises a good thermal conductor material, so as to dissipate heat generated by the solar energy utilization device to environment.

14. The solar energy system according to claim 1, wherein the reflector is foldable;
wherein the solar energy system further comprises a driving device for driving the reflector to switch between an expanded state and a retracted state.

15. The solar energy system according to claim 14, wherein the reflector is provided with a plurality of transverse creases extending generally in a transverse direction of the reflector and a plurality of longitudinal creases extending generally in a longitudinal direction of the reflector, and the reflector can be folded along the creases; wherein the longitudinal creases and the transverse creases are perpendicular or at an angle to each other;
wherein in the retracted state, each transverse crease is folded in a same way and in a zigzag manner, so that the reflector is retracted in the transverse direction, and odd-numbered transverse creases are located on one side of the reflector in the retracted state while even-numbered transverse creases are located on the opposite side of the reflector in the retracted state.

16. The solar energy system according to claim 15, wherein
each longitudinal crease is folded in a zigzag manner in a plane perpendicular or at an angle to the one side or the opposite side of the reflector, so that the reflector is retracted in the longitudinal direction.

17. The solar energy system according to claim 15, wherein the plurality of transverse creases and the plurality of longitudinal creases divide the reflector into a plurality of quadrilateral pieces.

18. The solar energy system according to claim 17, wherein the quadrilateral pieces are parallelograms.

19. The solar energy system according to claim 17, wherein some quadrilateral pieces are different from other quadrilateral pieces in shape and size.

20. The solar energy system according to claim 17, wherein all of the quadrilateral pieces are in same shape and size.

21. The solar energy system according to claim 17, wherein each quadrilateral piece is made of a rigid material, and adjacent quadrilateral pieces are rotatably coupled together.

22. The solar energy system according to claim 17, wherein the reflector is composed of an integral flexible material.
